(19) United States
(12) Patent Application Publication
(10) Pub. No.: US 2006/0071516 A1
(43) Pub. Date: Apr. 6, 2006

(54) Male bike or exerciser seat

(76) Inventor: Raffaele Martini Pandozy, New York, NY (US)

Correspondence Address: RAFFAELE MARTINI PANDOZY , PH.D., 2312 GRAND AVE. APT A., DALLAS, TX, 75215, US

(21) Appl. No.: 10/957,025

(22) Filed: Oct. 1, 2004

(51) Int. Cl. B62J 1/00; B62J 1/22; B62J 1/18

(52) U.S. Cl. 297/202; 297/214; 297/201

(57) ABSTRACT

A bicycle or exerciser seat anatomically designed to accommodate, support, protect, and relieve the male genitals from the pressure and friction exercised by the body's weight when riding on ordinary bike seats or exerciser seat, and in particular, to safeguard the testis, which are otherwise squeezed between the leg and the front part, (the bird beak shape part) of ordinary seats during legs' movement, thus resulting in inflammation, injuries to the genitals, sexual impotence, and other serious pathologies. This novel seat also provides for two proper and comfortable resting points for the Ischial bones of the torso to rest on, and relief for the Urethral duct and other sexual soft tissues from pressure exercised by ordinary bike or exerciser seats. In addition, with this design the male genitals are supported and maintained at the center between the legs thus conferring confort, safer physical conditions, better control of the bike, and greater freedom of movement.

### BACKGROUND OF THE INVENTION

1. The Field of Invention

This invention relates to a bicycle or bike exerciser seat, more in particular, to the field of anatomical bike seat designs. The seat has been tested to meet all expectations of comfort and reliability for it centers the body on the bike by properly and safely accommodating the male genitals in a especially designed habitat that confers greater freedom of movement and performance. Most importantly, by placing the genitals in their most suitable location, at the center and above the leg movement, thereby eliminating pressure and friction and avoiding certain traumatic medical complications much too common with bike riders.

The problem facing male bike riders using common bike seats, especially those with pointed, bird beak like frontal shapes, accidentally squeeze the male genitals either to the right or to the left against the thigh, thereby exercising dangerous pressure to either side of them, as well as restricting leg movements. Women bikers, obviously, do not have this problem.

The most common medical problem occurring to male bikers, are inflammation and subsequent damages of genital soft parts, such as, the bulbourethral gland, the urogenital diaphragm, the epididymis of the testicles, etc., all parts that when damaged can cause impotence and other more severe pathological complications.

The solution to this problem and the objective of this invention was therefore to arrive at the design of an anatomically correct bike seat that properly accommodates, isolate, and protects the male genitals by isolating them from the pressure of the body's weight and supporting them as to avoid interfering with the leg movement, which ultimately provide greater freedom to same, more comfort, and better control of the bike.

An anatomically correct bike seat is also one that provides proper, comfortable area for the upper body's two major skeletal resting points, namely, the Ischial Tuberous bones, which are the bases on which the entire weight of the torso gravitates in a normal sitting position. In common bike seats instead the entire weight of the upper body ends up resting on the soft tissues of the urethral duct, which is the cause of many biker's major health problems. By providing two elevated, comfortable and reliable resting points for the Ischial bones, automatically we obtain a free zone for the urethral duct, which is then free from the body's weight pressure.

2. The Related Prior Art in U.S. Patent

U.S. Pat. No. 5,720,518 granted to Mr. Craig R. Harrison discloses a bike seat accessory providing 2 oval shaped, multilayered pads for greater convert and shock absorption, but that does not address, nor resolve any of the pathological and dynamic problems stated in the Field of Invention.

U.S. Pat. No. 5,147,685 granted to Mr. Chris A. Hanson, discloses a design of Padding Device made of “flowable” material of various density distributed in three zones of the seat. This invention also does not address, nor resolve any of the dynamic and pathological problems described in the Field of Invention.

U.S. Pat. No. 3,807,793 granted to Mr. David L. Jacobs, discloses a bicycle seat with various padded compartments, which according to the inventor, are supposed to provide more stability, but that do not address, nor resolve the dynamic and pathological problems stated in the Field of Invention.

U.S. Pat. No. 4,504,089 granted to Nathaniel Calvert, discloses a liquid cushioned bicycle Seat that molds around the buttock of the biker, but that does not address, nor resolve any of the dynamic and pathological problems stated in the Field of Invention.

### SUMMARY OF THE INVENTION

A bicycle seat anatomically designed to accommodate, isolate and protect the mate genitals from inflammation, swelling and more serious pathological conditions caused by body weight pressure and friction during leg action to the male genitals and one that completely frees legs' movement for better performance and more riding pleasure. The scat's body can be molded in one piece and the invention idea is to provide an anatomically designed surface with an anterior central cavity that accommodates the male genitals and a central concave channel across the seat to provide a free and safe zone for the urethral duct, without depriving the rider of the bird beak like, elongated part of the seat that serves as bike control. The seat must therefore be so designed to accommodate any male buttock and fit comfortably like a piece of clothing. Various, more or less elastic foam, vinyl or other leather or plastic type materials can be employed for the realization of this bike seat. The body of the seat may be supported by a plastic or metal frame and provided with universal fastening devices.

### BRIEF DESCRIPTION OF THE DRAWINGS

FIG. 1 shows a perspective view of the entire field of invention with numeric references.

FIG. 2 is a schematic view of the Bicycle seat with numeric references.

### DESCRIPTION OF THE PREFERRED EMBODIMENT

The MALE BIKE OR EXERCISER SEAT, like any ordinary bike seats, may comprise a plastic or metal frame, some springs for shock absorption and support, foam rubber for padding and vinyl or leather for covering. These elements are not part of the field of invention.

The novel idea consists in the configuration of the surface of the seat, rather than its frame and mechanical construction.

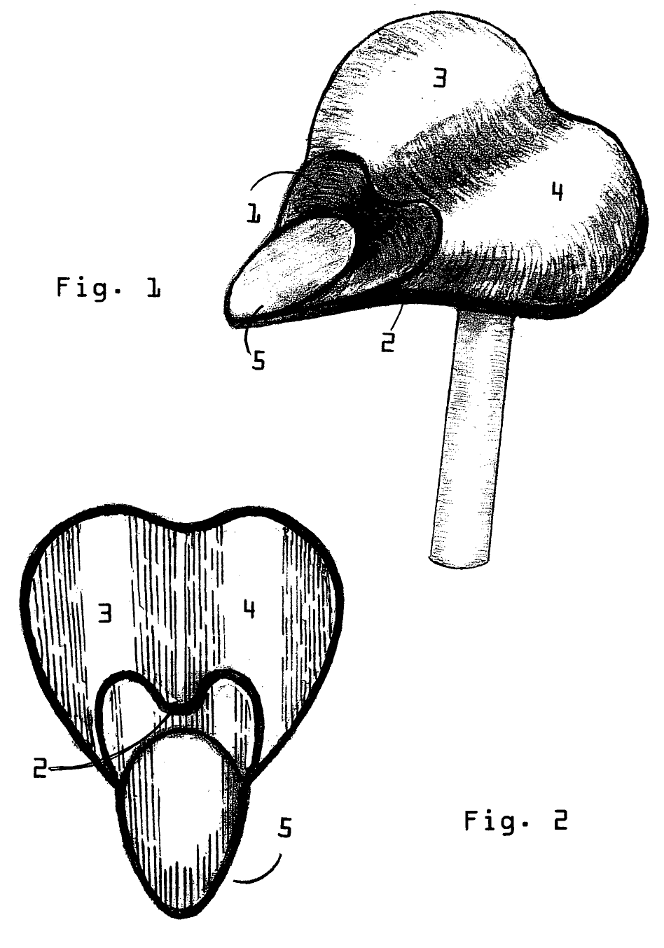

As shown in FIG. 1, the general body of the bike seat is molded in one piece into a special anatomical shape comprising a cavity 1 that offers a comfortable receptacle for accommodating the male genitals while riding the bike, and a special round elongated cavity or depression 2 designed to meet anatomically the inferior linguinal joint of the urethral duct and the testis of the biker. This point is important to be met because it accommodates the urethral duct and tells the biker that he is sitting in anatomical correct manner on the bike seat.

In an ordinary bike seat, especially when the rider is in a reclined forward position, most of the weight of the male user's body gravitates on the Bulbourethral duct and gland producing dangerous pressure, inflammation and more serious pathological conditions. The pressure and the damage may then extend to the Perineal membrane, and to the Urogenital diaphragm, which in the long run may cause sexual disorders. By creating an anatomical cavity in the frontal part of the bike seat, the rider's body weight is forced to rest exclusively, where it belongs, namely, on the two designated areas 3 and 4 allocated to the Ischial bones. These two areas 3 and 4, as shown in FIGS. 1 and 2, are the highest points designed to perform the greatest cushioning function. With this novel idea, the pressure against the above mentioned soft body parts is eliminated and both testicles and penis are placed in a properly shaped concave space situated at the center of the bike seat, which maintains its elongated base 5, which, by being situated between the thighs of the rider, serves as instrument of control and stabilization of the bike.

In sum, the seat is designed to maintains and perform all its functions better, adapting to the true anatomical part of the male buttock. It provides sufficient area to comfortably accommodate the biker's testis, which are otherwise caught in between the front part of ordinary seats and the leg, and allows proper place for all other soft tissues. In addition, it provides two specially cushioned resting areas for the Ischial bones, which are the logical points on which to rest the body weight.

1. A bike or exerciser scat, or saddle that is specifically designed to fit men's anatomy and to comprise any type of receptacle spaces for accommodating the male's genitals.

2. A bike or exerciser scat, in accordance with claim 1, providing an anatomical, frontal, horizontal receptacle space that is anatomically designed to accommodate and protect the male genitals, and keep them at the center of the body as to allow free legs' movement for the user.

3. A bike or exerciser seat, or saddle in accordance with claim 1, providing an anatomically designed receptacle place comprising a prolonged pointed shape as to provide sufficient extension leg leverage, control and stability of the bicycle.

4. A bike or exerciser seat in accordance with claim 1, providing a central cavity for accommodating and prevent pressure on the urethral by the biker's body weight.

5. A bike or exerciser seat in accordance with claim 1, providing a special round indentation in line with the lower extremity urethral duct and the testis, to make the biker feel that the seat is in place during movement, thus avoiding pressure, subsequent blood circulation blockage and other anomalies.
